(19) United States
(12) Patent Application Publication
(10) Pub. No.: US 2002/0190244 A1
(43) Pub. Date: Dec. 19, 2002

(54) Electrically conductive adhesive agent

(75) Inventor: Etsuro Iki, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/167,510

(22) Filed: Jun. 13, 2002

(30) Foreign Application Priority Data
Jun. 13, 2001 (JP) 2001-178038

(51) Int. Cl. H01B 1/00

(52) U.S. Cl. 252/500

(57) ABSTRACT

An electrically conductive adhesive agent includes at least an electrically insulative adhesive base material providing an adhesion; and at least an electrically conductive filler material mixed in the electrically insulative adhesive base material.

### BACKGROUND OF THE INVENTION

1. Field of the Invention

The present invention relates to an electrically conductive adhesive agent, and more particularly to an electrically conductive adhesive agent to be used for providing an electrical connection of electric devices, interconnections and wirings.

2. Description of the Related Art

A soldering method is one of widely used electrical connection methods for providing an electrical connection between electric devices, interconnections and wirings in fabrication of an electric circuit board. The soldering method is carried out by heating and melting a soldering material which is placed at an intended point or position for providing the electrical connection. It is, however, possible that the soldering results in a defect and/or that the heat used for melting the solder material causes heat conduction to one or more electrical devices which are positioned in the vicinity of the soldering point or position, whereby the electrical devices receive a large quantity of heat and becomes broken or dysfunction.

FIG. 1A is a fragmentary cross sectional elevation view of a solder-defect state in a soldering process for providing an electrical connection between pad and electric device. A pad 2 is provided on an electric circuit board 1. An electric device 3 is electrically connected to the pad 2 by using a solder material 5 and a flux 4. The flux 4 is solidified in the form of a flux layer which cover the pad 2. This flux layer 4 prevents the solder material 5 from becoming contact with the pad 2, whereby no electrical connection between the solder material 5 and the pad 2 can be established, namely results in the undesirable solder-defect.

FIG. 1B is a fragmentary cross sectional elevation view of a device-broken state due to heat by a soldering process for providing an electrical connection between pad and electric device. A pad 2 is provided on an electric circuit board 1. An electric device 3 is electrically connected to the pad 2 by using a solder material 5 and a flux 4. A heat is applied to the solder material 5 for melting the solder material 5. A part of the applied heat becomes conducted to the electric device 3, whereby the electric device 3 becomes broken and/or dysfunctional by the conducted heat.

In the above circumstances, the development of a novel electrically conductive adhesive agent free from the above problems is desirable.

### SUMMARY OF THE INVENTION

Accordingly, it is an object of the present invention to provide a novel electrically conductive adhesive agent free from the above problems.

It is a further object of the present invention to provide a novel electrically conductive adhesive agent for providing an electrical connection without causing any solder-defect and any thermal breaking of the electrical device.

The present invention provides an electrically conductive adhesive agent including : at least an electrically insulative adhesive base material providing an adhesion ; and at least an electrically conductive filler material mixed in the electrically insulative adhesive base material.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1A is a fragmentary cross sectional elevation view of a solder-defect state in a soldering process for providing an electrical connection between pad and electric device.

FIG. 1B is a fragmentary cross sectional elevation view of a device-broken state due to heat by a soldering process for providing an electrical connection between pad and electric device.

FIG. 2 is a fragmentary view illustrative of an example in use of the electrically conductive adhesive agent for bonding an electronic device and a conductive wire in accordance with the present invention.

FIG. 3A is a plan view illustrative of an example in use of the electrically conductive adhesive agent for bonding leads of an electronic device to pads as well as for bonding a core line of a conductive wire and a pad over an electronic circuit board in accordance with the present invention.

FIG. 3B is a cross sectional elevation view illustrative of the example in use of the electrically conductive adhesive agent, taken along an A-A line of FIG. 3A.

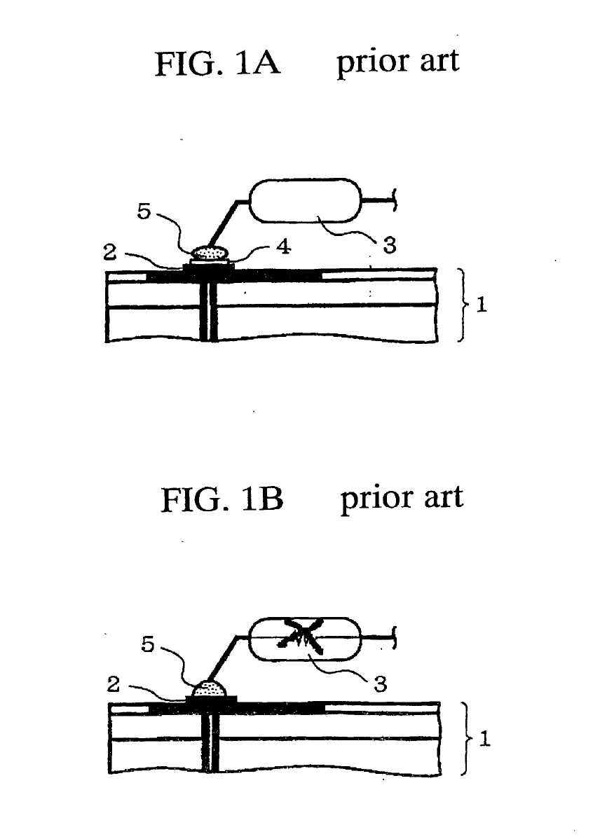

### DETAILED DESCRIPTION OF THE PREFERRED EMBODIMENTS

A first aspect of the present invention is an electrically conductive adhesive agent including: at least an electrically insulative adhesive base material providing an adhesion; and at least an electrically conductive filler material mixed in the electrically insulative adhesive base material.

It is preferable that the electrically conductive filler material comprises at least one electrically conductive resin material.

It is also preferable that the electrically conductive adhesive agent includes 60-80 wt-% of the electrically conductive filler material.

It is also preferable that the electrically conductive adhesive agent comprises: approximately 60-80 wt-% of the electrically conductive filler material ; and approximately 40-20 wt-% of the electrically insulative adhesive base material.

It is also preferable that the electrically conductive adhesive agent comprises: approximately 70 wt-% of the electrically conductive filler material ; and approximately 30 wt-% of the electrically insulative adhesive base material.

It is also preferable that the electrically conductive filler material comprises an electrically conductive resin material.

It is also preferable that the electrically conductive resin material comprises an electrically conductive polymer.

It is also preferable to further include: at least one of hardening agents and filler agents.

First Embodiment:

A first embodiment according to the present invention will be described in detail with reference to the drawings. In accordance with the present invention, the electrically conductive adhesive agent is capable of bonding or binding at least two portions or articles without carrying out any heat treatment in order to avoid the above problems and disadvantages which are engaged with the soldering process. The electrically conductive adhesive agent may include an electrically insulative adhesive base material which is capable of providing an adhesion, and an electrically conductive filler material which is mixed in the electrically insulative adhesive base material. The electrically conductive filler material may optionally and advantageously be at least one of electrically conductive resin materials. The electrically conductive adhesive agent may optionally and advantageously further include at least a hardening agent and/or at least a filler material an additional materials.

The electrically conductive filler material mixed in the electrically insulative adhesive base material provides an electrical connection. This makes it unnecessary to carry out the soldering process or the heat treatment. No soldering process nor heat treatment cause no problems as described above. The above electrically conductive adhesive agent in accordance with the present invention does not need any soldering process nor heat treatment. This prevents the electric device from being broken thermally and also from the defect of the bonding.

The above electrically conductive adhesive agent in accordance with the present invention may optionally and advantageously be prepared by mixing at least an electrically insulative adhesive agent material, at least an electrically conductive polymer which acts as an electrically conductive filler, and at least an additional material. A preferable example of the conductive filler may be polyacetylene powders. A preferable example of the electrically insulative adhesive agent material may be epoxy resin. The at least one additional material may advantageously and optionally include at least one of hardening agents and fillers. It is preferable that the electrically conductive filler material is free of metal powders such as silver or nickel or carbon powders for the purpose of avoiding any undesirable heat generation and any harmful substance.

A preferred example in composition of the electrically conductive adhesive agent in accordance with the present invention may advantageously and optionally comprises about 60-80 wt-% of the electrically conductive filler, about 40-20 wt-% of the electrically insulating adhesive agent material, and less than 1 wt-% of the one or more additional materials such as the hardening agent and the filler agent. Typically, in one preferable example, the composition of the electrically conductive adhesive agent may comprise about 70 wt-% of the electrically conductive polymer, about 30 wt-% of the insulating adhesive agent, and less than 1 wt-% of additional materials such as the hardening agent and the filler agent.

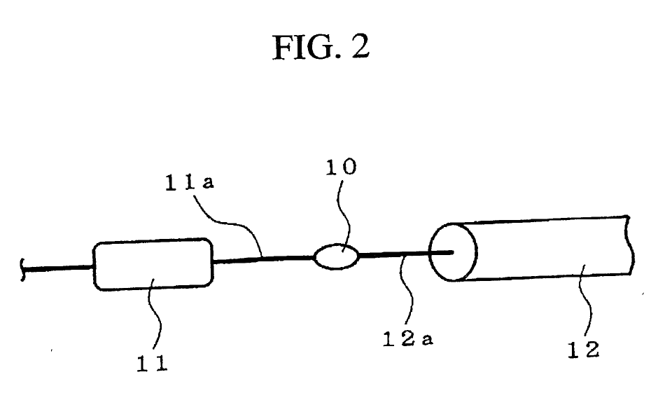

FIG. 2 is a fragmentary view illustrative of an example in use of the electrically conductive adhesive agent for bonding an electronic device and a conductive wire in accordance with the present invention.

The above described electrically conductive adhesive agent 10 in accordance with the present invention may optionally and advantageously be applicable to connect or bond a lead 11a of an electronic device 11 and a core line 12a of a conductive wire 12.

The connecting and bonding process is carried out at ordinary temperature using the electrically conductive adhesive agent 10 without any heat treatment process such as needed for melting the soldering material, resulting in no defect of the electrical connection nor thermal breaking the device in the vicinity of the bonding or connecting point. Namely, the electrically conductive adhesive agent 10 in accordance with the present invention ensures an electrical connection or bonding between the lead 11a of the electronic device 11 and the core line 12a of the conductive wire 12.

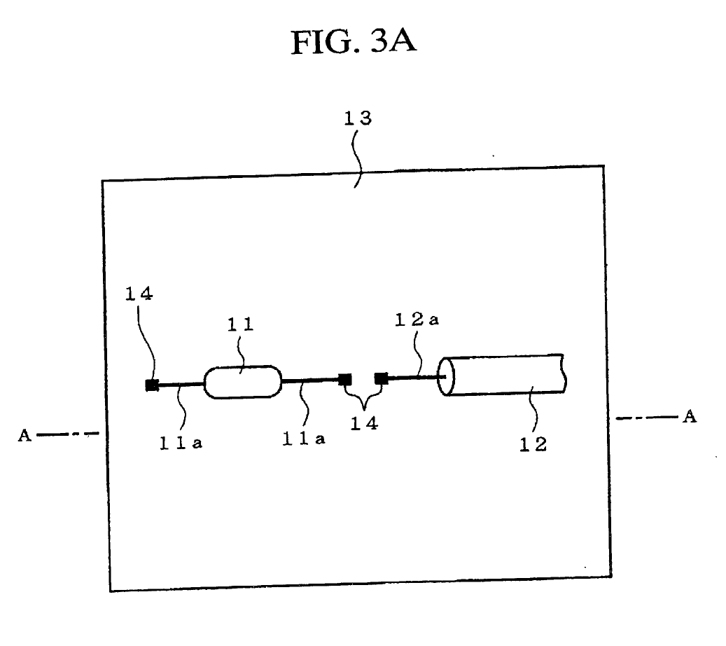

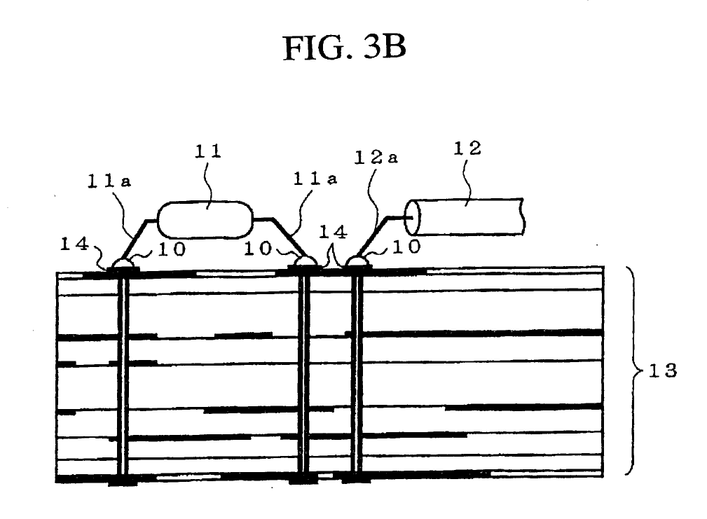

FIG. 3A is a plan view illustrative of an example in use of the electrically conductive adhesive agent for bonding leads of an electronic device to pads as well as for bonding a core line of a conductive wire and a pad over an electronic circuit board in accordance with the present invention. FIG. 3B is a cross sectional elevation view illustrative of the example in use of the electrically conductive adhesive agent, taken along an A-A line of FIG. 3A.

An electronic circuit board 13 comprises a multi-level printed circuit board which includes through holes and multi-level interconnections. A top surface of the electronic circuit board 13 has plural conductive pads 14. The electronic circuit board 13 may be used as a part of various jigs of measuring devices used for test processes of the semiconductor manufacturing processes. The above described electrically conductive adhesive agent 10 may optionally and advantageously be applicable to connect or bond each of leads 11a of an electronic device 11 to corresponding one of the pads 14 as well as connect or bond a core line 12a of a conductive wire 12 to corresponding one of the pads 14.

The connecting and bonding process is carried out at ordinary temperature using the electrically conductive adhesive agent 10 without any heat treatment process such as needed for melting the soldering material, resulting in no defect of the electrical connection nor thermal breaking the device in the vicinity of the bonding or connecting point. Namely, the electrically conductive adhesive agent 10 in accordance with the present invention ensures an electrical connection or bonding between each of the leads 11a of the electronic device 11 and the pad 14 as well as the core line 12a of the conductive wire 12 and the pad 14.

The above-described electrically conductive adhesive agent 10 in accordance with the present invention may optionally and advantageously be applicable to provide an electrical connection and bonding between any two points or parts.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. An electrically conductive adhesive agent including:
at least an electrically insulative adhesive base material providing an adhesion; and
at least an electrically conductive filler material mixed in said electrically insulative adhesive base material.

2. The electrically conductive adhesive agent as claimed in claim 1, wherein said electrically conductive filler material comprises at least one electrically conductive resin material.

3. The electrically conductive adhesive agent as claimed in claim 1, wherein said electrically conductive adhesive agent includes 60-80 wt-%-of said electrically conductive filler material.

4. The electrically conductive adhesive agent as claimed in claim 1, wherein said electrically conductive adhesive agent comprises:
approximately 60-80 wt-% of said electrically conductive filler material; and
approximately 40-20 wt-% of said electrically insulative adhesive base material.

5. The electrically conductive adhesive agent as claimed in claim 1, wherein said electrically conductive adhesive agent comprises:
approximately 70 wt-% of said electrically conductive filler material ; and
approximately 30 wt-% of said electrically insulative adhesive base material.

6. The electrically conductive adhesive agent as claimed in claim 1, wherein said electrically conductive filler material comprises an electrically conductive resin material.

7. The electrically conductive adhesive agent as claimed in claim 6, wherein said electrically conductive resin material comprises an electrically conductive polymer.

8. The electrically conductive adhesive agent as claimed in claim 1, further including: at least one of hardening agents and filler agents.
